(19) United States
(12) Patent Application Publication
(10) Pub. No.: US 2003/0226421 A1
(43) Pub. Date: Dec. 11, 2003

(54) Shock absorbing handle bar grip

(76) Inventor: Paul M. Livingston, Mission Viejo, CA (US)

Correspondence Address: MORLAND C FISCHER, 2030 MAIN ST, SUITE 1050, IRVINE, CA, 92614

(21) Appl. No.: 10/165,072

(22) Filed: Jun. 10, 2002

(51) Int. Cl. B62K 21/12

(52) U.S. Cl. 74/551.1

(57) ABSTRACT

A shock absorbing handle bar grip to surround the opposite ends of metal handle bars of the kind that are found on a conventional bicycle. The handle bar grip includes inner and outer elastomeric layers that are bonded together along an irregular boundary region. The inner elastomeric layer of the grip is denser than the outer elastomeric layer. The irregular boundary region includes successive V-shaped pairs of faces, where each V-shaped pair of faces are aligned to make an angle of approximately 60 degrees. By bonding the inner and outer elastomeric layers of the handle bar grip to one another along an angled boundary region, some of the shock waves that are transmitted from the metal handle bars will be reflected at the boundary region to be absorbed within the inner elastomeric layer of the grip. By controlling the direction of the reflected shock waves the rider's hands will feel less of the vibrations that are generated when the wheels of his bicycle travel over a rough or bumpy terrain.

### BACKGROUND OF THE INVENTION

1. Field of the Invention

This invention relates to a shock absorbing grip having particular application for surrounding the opposite ends of metal handle bars of a bicycle, or the like, to minimize the shock that is transmitted from the handle bars to the hands of a rider while riding his bicycle over a rough or bumpy terrain.

2. Background Art

FIG. 1 of the drawings shows a portion of a typical bicycle 1 having a pair of metal handle bars 3 to be grasped by the rider to enable him to improve his balance and control the direction in which the bicycle will travel. The end of each of the handle bars 3 is commonly surrounded by a grip 5. The grips 5 at opposite ends of the handle bars 3 are held in place by means of a snug friction fit. The grips 5 establish a convenient and comfortable location around which the rider can wrap his hands to gain a firm grasp of the handle bars 3.

As will be known to riders of all ages, a bicycle may often travel over rough and bumpy terrain. The impact forces that are generated as the bicycle wheels ride over such terrain are transmitted to the hands of the rider in the form of shock waves that are propagated along the bicycle frame 7 and the handle bars 3 to the grips 5. Under certain conditions, the magnitude of the shock waves reaching the rider's hands can result in a steady vibration and discomfort over time. In other cases, the shock waves may interfere with the rider's ability to control his bicycle.

Accordingly, it would be desirable to have available a handle bar grip to fit over each end of the handle bars 3 of the conventional bicycle 1 so as to reduce the magnitude of the impact forces and the vibrations that are transmitted to the hands of the rider to thereby increase the comfort of his ride and maximize his ability to control the bicycle.

One example of a bicycle handle bar grip that is manufactured from inner and outer layers of material having different densities is available by referring to U.S. Pat. No. 6,112,618 issued to P. M. Yates.

### SUMMARY OF THE INVENTION

A cylindrical shock absorbing handle bar grip is disclosed of the kind that surrounds each of the opposite ends of the metal handlebars of a bicycle, or the like, to be grasped by the hands of a rider. The bicycle grip of this invention includes an inner elastomeric layer that is surrounded by and bonded to an outer elastomeric layer. The inner elastomeric layer is denser than the outer elastomeric layer by a ratio of at least 2 to 1. The boundary region between the inner and outer elastomeric layers has an irregular, cylindrical configuration. More particularly, the boundary region of the bicycle grip includes successive V-shaped pairs of faces, where one face of each pair of faces is aligned with the opposing face to make an angle of approximately 60 degrees. By bonding the inner and outer elastomeric layers of the handle bar grip to one another along an angled boundary region, the majority of the shock waves that are transmitted from the metal handle bars will be reflected by the V-shaped faces of the boundary region in a direction away from the rider's hands. By virtue of the foregoing, the rider's hands will feel less of the vibrations that are generated when the wheels of the rider's bicycle travel over a rough or bumpy terrain. Accordingly, the rider will be provided with a more comfortable grasp of the handle bars and the ability to better control the operation of his bicycle.

### BRIEF DESCRIPTION OF THE DRAWINGS

FIG. 1 shows the handle bars of a bicycle to which the shock absorbing handle bar grips of this invention are applicable;

FIG. 2 shows the cross-section of a conventional handle bar grip taken along lines 2-2 of FIG. 1; and

FIG. 3 shows the cross-section of the shock absorbing handle bar grip which forms this invention.

### DETAILED DESCRIPTION

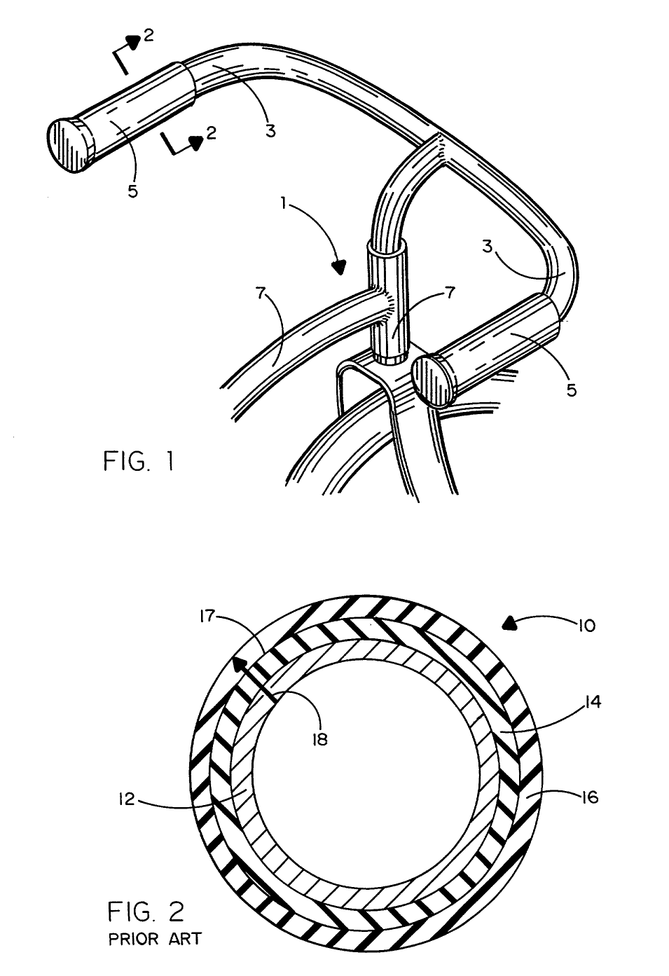

Turning now to FIG. 2 of the drawings, there is shown the cross-section of a conventional grip 10 of the type that has heretofore been used to cover the opposite ends of the metal handle bars 12 of a bicycle, or the like, such as that shown in FIG. 1. In many cases, the conventional grip 10 is manufactured from a single continuous elastomeric and/or plastic material. In other cases, like that shown in FIG. 2, the grip 10 is manufactured from inner and outer layers 14 and 16 having a boundary or interface 17 lying therebetween.

In either case, the boundary region 17 located between the inner and outer layers 14 and 16 is uniformly cylindrical in shape. That is to say, the boundary region 17 forms a smooth, regular surface at the interface of layers 14 and 16. Consequently, the majority of the shock waves (e.g. designated 18 in FIG. 2) that are propagated along the metal handle bars 12 are transmitted through layers 14 and 16 as well as the regular cylindrical boundary region 17 lying therebetween. While some of the shock waves 18 are intercepted and randomly reflected by the cylindrical boundary region 17, there is nothing in the conventional handle bar grip 10 to control the direction in which the shock waves are reflected so as to prevent their transmission to the hands of the rider. Thus, and as pointed out above, the hands of the rider will be subjected to vibrations which can adversely affect the comfort of his grip and his ability to control the operation of his bicycle.

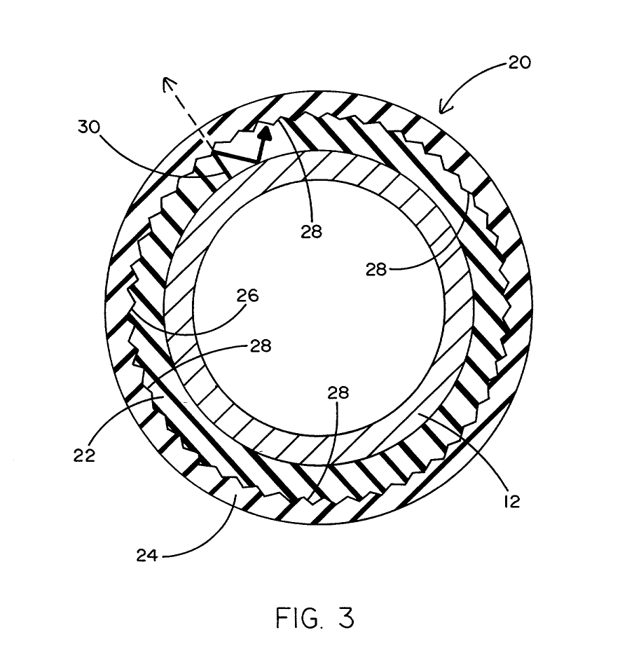

FIG. 3 of the drawings shows the improved shock absorbing handle bar grip 20 which forms the present invention and overcomes the inherent problems with the conventional grip 10 that was described above when referring to FIG. 2. The shock absorbing handle bar grip 20 has a cylindrical configuration and includes inner and outer elastomeric layers 22 and 24. By way of example only, the elastomers from which the inner and outer layers 22 and 24 of grip 20 are manufactured are sold under the trademarks KRATON by Shell Oil Company or SANTOPRENE by Monsanto Company.

The inner elastomeric layer 22 of handle bar grip 20 is relatively dense and firm so as to establish a close and reliable friction attachment of grip 20 around the metal handle bar 12 of a bicycle. The outer elastomeric layer 24 of grip 20 is relatively soft so as to provide a comfortable feel when the handle bar grip 20 is in the grasp of the rider. Preferably, the inner elastomeric layer 22 of grip 20 is at least twice as dense as the outer elastomeric layer 24. More particularly, the inner elastomeric layer 22 has a durometer of about 60, and the outer elastomeric layer 24 has a durometer of about 25.

During manufacture of the shock absorbing handle bar grip 20, the inner elastomeric layer 22 is initially formed by pouring the elastomer into a suitable mold (not shown). While the temperature of the inner layer is raised to about 800 degrees F., the outer elastomeric layer 24 is formed by injecting the elastomer into the mold. Suitable pressure is then applied to the inner and outer elastomers. The combination of heat and pressure causes the inner and outer elastomeric layers 22 and 24 of handle bar grip 20 to be molecularly interlocked and bonded together along a continuous boundary region 26.

As an important detail of the shock absorbing handle bar grip 20 of FIG. 3, the aforementioned boundary region 26 between the inner and outer elastomeric layers 22 and 24 is irregular. That is, the boundary region 26 includes successive V-shaped pairs of faces, where one face of each pair of faces is aligned with the opposing face so as to make an angle of approximately 60 degrees. By virtue of bonding the inner and outer elastomeric layers 22 and 24 of the handle bar grip 20 to one another along an irregular (i.e. angled) shaped boundary region 26, the surface area of the boundary region 26 will be increased so that a majority of the shock waves (designated 30) that are transmitted from the metal handle bars 16 are more likely to be reflected by one of the angled faces 28. The angle shaped boundary region 26 enables the direction of reflection to be more effectively controlled, whereby the reflected shock wave 30 will be directed back towards the metal handle bars 12. The principal component of the shock wave 30 continues to be reflected between the angled boundary region 26 and the metal handle bars 12 so as to be absorbed within the dense inner elastomeric layer 22 and therefore substantially dissipated by the shock absorbing handle bar grip 20. Thus, the magnitude of any shock waves 28 that are transmitted through the angled boundary region 26 and outwardly of the outer elastomeric layer 24 will be significantly reduced.

Accordingly, the rider's hands will feel less of the vibrations that are generated when the wheels of the rider's bicycle travel over a rough or bumpy terrain. In this same regard, the rider will be provided with a more comfortable grasp of the handle bars 12 and the ability to better control the operation of his bicycle.

Although the shock absorbing handle bar grip of this invention has particular application for reducing the transmission of shock waves propagating along the handle bars of a bicycle, it is to be expressly understood that the shock absorbing grip herein disclosed is also adapted to fit over and surround other tubular bodies along which mechanically generated and transient vibrations are normally transmitted to the hands of a user. Such bodies to which the grip of this invention is also applicable include, but are not limited to, golf clubs, baseball bats and the handle bars of motorcycles, scooters and the like.

I claim:

1. A shock absorbing grip to surround a body to be held in the hand of a user and along which shock waves are propagated and transmitted to the user's hand, said shock absorbing grip comprising means by which to reflect the shock waves that are transmitted from the body in a direction away from the user's hand so that the shock waves are dissipated within said grip.

2. The shock absorbing grip recited in claim 1, further comprising an inner layer to surround the body along which the shock waves are propagated and an outer layer surrounding the inner layer and around which the user's hand is wrapped, said means by which to reflect the shock waves being located at the interface between said inner and outer layers.

3. The shock absorbing grip recited in claim 2, wherein each of said inner and outer layers is an elastomeric material.

4. The shock absorbing grip recited in claim 3, wherein said inner and outer elastomeric layers are bonded to one another along said interface by means of heat and pressure.

5. The shock absorbing grip recited in claim 3, wherein said inner elastomeric layer is denser than said outer elastomeric layer.

6. The shock absorbing grip recited in claim 5, wherein said inner elastomeric layer has a durometer which is at least twice the durometer of said outer elastomeric layer.

7. The shock absorbing grip recited in claim 2, wherein the interface between said inner and outer layers at which the shock waves are reflected away from the hand of the user includes an irregular surface.

8. The shock absorbing grip recited in claim 7, wherein the interface between said inner and outer layers includes successive V-shaped pairs of faces by which to form said irregular surface, the faces of each V-shaped pair of faces being aligned at an angle relative to one another.

9. The shock absorbing grip recited in claim 8, wherein the faces of each V-shaped pair of faces which form the irregular surface at the interface between said inner and outer layers make an angle of approximately 60 degrees.

10. A shock absorbing grip to surround a metallic tubular body that is to be held in the hand of a user and along which shock waves are propagated and transmitted to the user's hand, said shock absorbing grip comprising an inner elastomeric layer to surround the tubular body along which the shock waves are propagated, an outer elastomeric layer surrounding the inner layer and around which the user's hand is wrapped, and an interface region located between said inner and outer elastomeric layers by which to reflect the shock waves transmitted from said tubular body away from the user's hand so that the shock waves are dissipated within the inner elastomeric layer of said grip, said interface region having successive V-shaped pairs of faces, wherein the faces of each V-shaped pair of faces are aligned to make an angle relative to one another.
